(19) United States
(12) Patent Application Publication
(10) Pub. No.: US 2009/0080517 A1
(43) Pub. Date: Mar. 26, 2009

(54) Method and Related Device for Reducing Blocking Artifacts in Video Streams

(76) Inventors: Yu-Ling Ko, Hsinchu City (TW); Chien-Chih Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/858,894

(22) Filed: Sep. 21, 2007

(51) Int. Cl. H04B 1/66

(52) U.S. Cl. 375/240.03

(57) ABSTRACT

A method for reducing blocking artifacts in a video stream comprises receiving a picture of the video stream, wherein the picture includes a plurality of macroblocks and each of the plurality of macroblock includes four blocks, determining blocks with quantization parameters greater than a first threshold value in the picture, checking if block boundaries of the blocks are sharp and are real edges of objects in the picture according to pixel value differences between two adjacent pixels respectively located at both sides of the block boundaries, selecting filtering strengths of a de-blocking operation according to the pixel value differences when the block boundaries are sharp and are not real edges of the objects in the picture, and performing the de-blocking operation for two adjacent blocks at both sides of the block boundaries.

### BACKGROUND OF THE INVENTION

1. Field of the Invention

The present invention relates to a method and related device for reducing blocking artifacts in a video stream, and more particularly, to a method and related device for providing detection of the blocking artifacts and removing the blocking artifacts with adaptive de-blocking filtering strengths.

2. Description of the Prior Art

A wide range of new applications in visual communications have been made possible due to the rapidly evolving telecommunication and computer industries. Almost all the related applications, including video conferencing, mobile or PSTN video telephony, video over the Internet Protocol, and digital TV broadcasting, require very efficient data compression methods to fit a large amount of visual information into the narrow bandwidth of communication channels while preserving acceptable quality of the reconstructed data.

To efficiently compress a time variable video sequence, redundancy in the temporal domain as well as in the two dimensional spatial domain must be reduced. The Moving Picture Experts Group (MPEG) standards use a discrete cosine transform (DCT) for processing the steps of reducing the redundancy in the two dimensional spatial domain and a motion estimation method for processing the steps of reducing the redundancy in the temporal domain.

The prior art video compression technique performs DCT operations, if necessary, after input data is sampled into 8×8 units, and DCT coefficients are quantized with respect to a visual property using quantization parameters from a quantization table. Then, the data is compressed through a run length coding (RLC). The data processed with DCT is converted from a spatial domain to a frequency domain and compressed with the quantization parameters corresponding to the visual property of human beings, not to be visually recognized. For example, since human eyes are insensitive to high frequency images, a high frequency coefficient is quantized using a large step size. Thus, a quantization table is made according to external parameters, such as a display characteristic, watching distance, and noise, to perform an appropriate quantization.

Please refer to FIG. 1. FIG. 1 shows a plurality of adjacent 8×8 pixel blocks 100, 102, 104 used according to the above described MPEG compression. In processing a moving picture as discussed above, these blocks 100, 102, 104 are individually processed to maximize the compression ratio and coding efficiency. However, this individual processing causes blocking artifacts that are noticeable at boundaries between blocks because of DCT and quantization effect. Both horizontal block boundaries 106 and vertical block boundaries 108 are present and tend to cause square patterns (i.e. blocking artifacts) that are quite apparent to the human eye.

In the traditional block-based video compression standards such as MPEG-2, the blocking artifact is the most noticeable artifact. Thus, various methods for reducing blocking artifacts in decoding systems that individually processes blocks have been developed. For example, a de-blocking filter can be integrated into a decoding system as either an in-loop filter or a post-processing filter. Compared with the in-loop filter, the post-processing filter performs a de-blocking process for a decoded bit stream outside a decoding loop of the decoding system. Thus, the post-processing filter can operate in conjunction with the original video compression standards. In other words, the post-processing filter can be easily integrated into any standard decoder using various implementation methods designed independent of the standard.

As shown in FIG. 1, after decompressed by MPEG-2 decoders, the blocking artifacts may occur on the block boundaries of the 8×8 pixel blocks. Then, the post-processing filter of the prior art performs the de-blocking process for all the blocks of the decoded bit stream for weakening the apparent boundary lines of the block boundaries, so as to reduce the blocking artifacts and enhance the image quality. However, in reality, the block boundaries of the 8×8 pixel blocks in a picture are not totally apparent to the human eyes, i.e. existing the blocking artifacts, and thus it is not necessary to perform the de-blocking process for all of the blocks. When all of the blocks are directly performed the de-blocking process without any block detection or selection, some blocks which are not necessary to be performed the de-blocking process may blur, and unnecessary calculation is consumed, so that the efficiency of the decoding system cannot be optimized.

Besides, since the video stream inputted to the decoding system may have various image characteristics or may come from different video sources like digital versatile discs (DVDs) and digital TV, if all of the 8×8 pixel blocks are performed the de-blocking process with fixed filtering strength, the blocks may also blur or still exist apparent boundary lines, which influences the image quality of the decoding system. However, the demand for de-blocking filtering of MPEG-2 encoded video is increasing due to the wide acceptance of MPEG-2 applications, such as DVD and digital TV.

### SUMMARY OF THE INVENTION

It is therefore a primary objective of the present invention to provide a method and related device for reducing blocking artifacts in video streams.

The present invention discloses a method for reducing blocking artifacts in a video stream. The method comprises receiving a picture of the video stream, the picture comprising a plurality of macroblocks and each of the plurality of macroblock comprising four blocks; determining blocks with quantization parameters greater than a first threshold value in the picture; checking if block boundaries of the blocks are sharp and are real edges of objects in the picture according to pixel value differences between two adjacent pixels respectively located at both sides of the block boundaries; selecting filtering strength of a de-blocking process according to the pixel value differences when the block boundaries are sharp and are not real edges of the objects in the picture; and performing the de-blocking process for two adjacent blocks at both sides of the block boundaries.

The present invention further discloses a de-blocking device for reducing blocking artifacts in a video stream. The de-blocking device comprises a reception terminal, a blocking artifact detection unit and a blocking artifact elimination unit. The reception terminal is utilized for receiving a picture of the video stream, wherein the picture includes a plurality of macroblocks and each of the plurality of macroblock further includes four blocks. The blocking artifact detection unit comprises a block determination unit coupled to the reception terminal for determining blocks with quantization parameters greater than a first threshold value in the picture, and a block boundary determination unit coupled to the block determination unit for checking if block boundaries of the blocks are sharp and are real edges of objects in the picture according to pixel value differences between two adjacent pixels respectively located at both sides of the block boundaries. The blocking artifact elimination unit comprises a filtering strength selection unit coupled to the block boundary determination unit for selecting filtering strengths of a de-blocking operation according to the pixel value differences when the block boundaries are sharp and are not real edges of the objects in the picture, and a de-blocking filtering unit coupled to the filtering strength selection unit for performing the de-blocking operation for two adjacent blocks at both sides of the block boundaries.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a plurality of adjacent 8×8 pixel blocks used according to the above described MPEG compression.

FIG. 2 is a schematic diagram of a process for reducing blocking artifacts in a video stream according to the present invention.

FIG. 3 is a schematic diagram of a plurality of adjacent macroblocks in a picture decompressed from an MPEG-2 decoder.

FIG. 4 and FIG. 5 are schematic diagrams of pixels located at both sides of the vertical and horizontal block boundaries that exist blocking artifacts.

FIG. 6 and FIG. 7 are schematic diagrams of pixel values corresponding to pixels at both sides of the block boundaries before and after performing the de-blocking operation, respectively.

FIG. 8 is a function block diagram of a video decoding system according to the present invention.

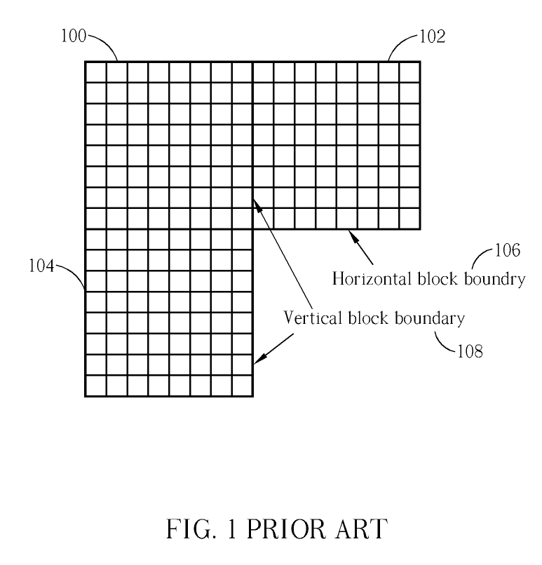

### DETAILED DESCRIPTION

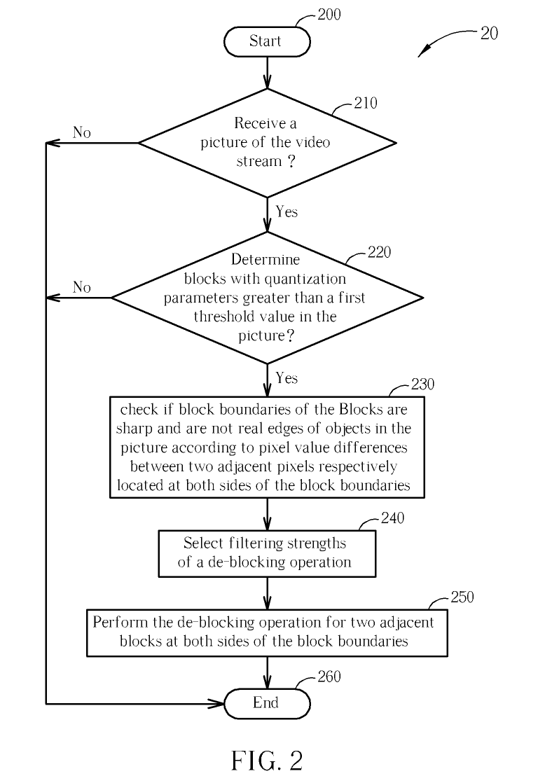

Please refer to FIG. 2. FIG. 2 is a schematic diagram of a process 20 for reducing blocking artifacts in a video stream according to the present invention. The process 20 is utilized for the video stream decompressed according to MPEG-2 standard, and includes the following steps:

Step 200: start.

Step 210: receive a picture of the video stream.

Step 220: determine blocks with quantization parameters greater than a first threshold value in the picture.

Step 230: check if block boundaries of the blocks are sharp and are not real edges of objects in the picture according to pixel value differences between two adjacent pixels respectively located at both sides of the block boundaries.

Step 240: select filtering strengths of a de-blocking operation.

Step 250: perform the de-blocking operation for two adjacent blocks at both sides of the block boundaries.

Step 260: end.

According to the process 20, after receiving the picture of the video stream decompressed by an MPEG-2 decoder, the present invention first determines blocks with the quantization parameters greater than the first threshold value in the picture, and then check if block boundaries of the blocks are sharp and are not real edges of objects in the picture according to pixel value differences between two adjacent pixels respectively located at both sides of the block boundaries. When the block boundaries are sharp and are not real edges of the objects in the picture, the present invention selects appropriate filtering strengths of the de-blocking operation according to the pixel value differences, and performs the de-blocking operation for two adjacent blocks at both sides of the block boundaries. Note that, the picture decompressed from the MPEG-2 decoder includes a plurality of macroblocks, and each of the plurality of macroblocks further includes four 8×8 pixel blocks.

Therefore, before performing the de-blocking operation, the present invention can detect the blocks that exist the blocking artifacts on their bock boundaries according to decoding information of the MPEG-2 decoder (such as quantization parameters) and the image characteristics (such as the pixel value differences), so that the efficiency of the decoding system can be enhanced significantly. Moreover, the present invention can perform the de-blocking operation for the blocks with the blocking artifacts by adaptive filtering strengths, and thus the blocking artifacts can be eliminated effectively and the desired image quality can be obtained as well. As for the detailed description of the process 20, please further refer to the following illustration.

As those skilled in the art recognized, the decoding information, such as the quantization parameter corresponding to each macroblock in the picture, can be obtained during the MPEG-2 decompression process, and a larger quantization parameter means that the step sizes used to quantize the pixel values are larger, so that the blocking artifacts may occurs on block boundaries of the blocks with large quantization parameters. Thus, by determining the blocks with the quantization parameters greater than the first threshold value in the picture (Step 220), the present invention can detect the blocks that exist the blocking artifacts. In other words, if the quantization parameters of the blocks are greater than the first threshold value, the present invention determines that the blocking artifacts may exist on block boundaries of the blocks, so that the following steps of the process 20 are performed for the corresponding boundaries.

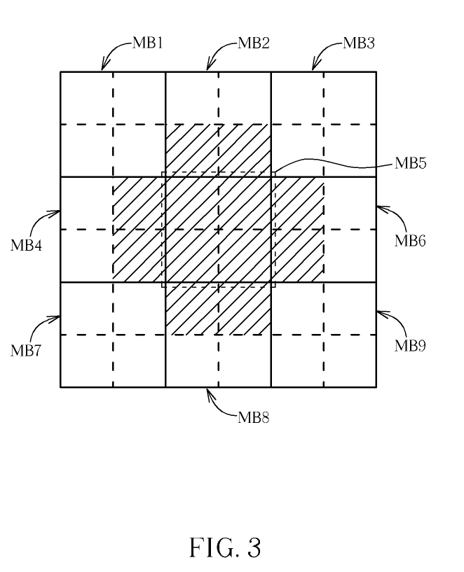

For example, please refer to FIG. 3. FIG. 3 shows a plurality of adjacent macroblocks MB1˜MB9 in a picture decompressed from an MPEG-2 decoder. As shown in FIG. 3, each of the macroblocks MB1˜MB9 includes four 8×8 pixel blocks. If the quantization parameter corresponding to the macroblock MB5 is larger than the first threshold value, the present invention then determines that the block boundaries of the blocks in the macroblock MB5 may exist the blocking artifacts. That means, the adjacent blocks at both sides of the block boundaries, i.e. the shaded blocks in FIG. 3, have to be perform following steps of the process 20 for eliminating the blocking artifacts. Generally speaking, the de-blocking operation is respectively performed for the vertical block boundaries and the horizontal block boundaries that exist the blocking artifacts. Thus, when processing vertical block boundaries, as long as one of the quantization parameters of the two left and right adjacent blocks is greater than the first threshold value, the two adjacent blocks are determined to have the blocking artifacts. Similarly, when processing horizontal block boundaries, as long as one of the quantization parameters of the two up and down adjacent blocks is greater than the first threshold value, the two adjacent blocks are determined to have the blocking artifacts and have to be performed the following steps of the process 20. Preferably, in the present invention, the first threshold value is not a fixed value, but can be adjusted according to the desired image quality and the processing efficiency.

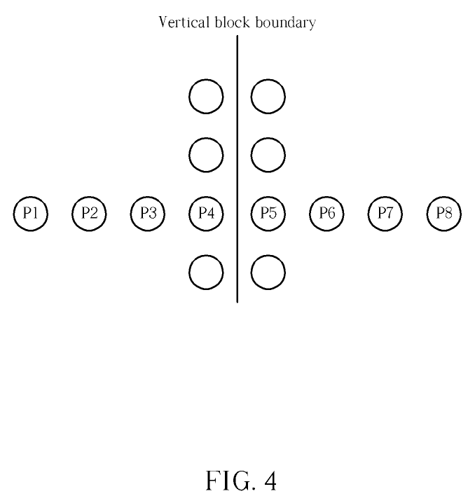

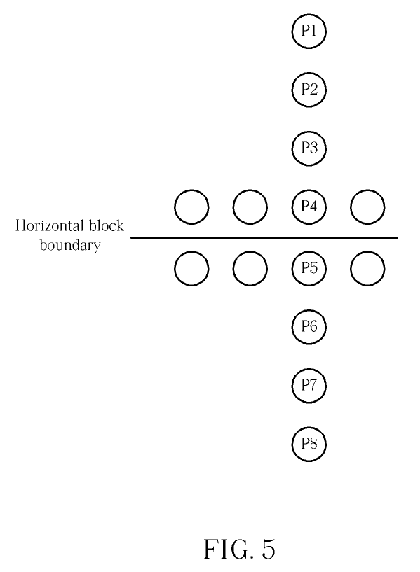

When the blocks are determined to have the blocking artifacts on their block boundaries, the present invention checks if the block boundaries of the blocks are sharp and are not real edges of the objects in the picture according to pixel value differences between two adjacent pixels respectively located at both sides of the block boundaries (Step 230). Please refer to FIG. 4 and FIG. 5. FIG. 4 and FIG. 5 shows pixels P1˜P8 respectively located at both sides of the vertical and horizontal block boundaries that exist blocking artifacts. First, the present invention calculates the pixel value differences between the two adjacent pixels respectively located at both sides of the block boundaries, i.e. the pixel value differences between the pixels P4 and P5 in FIG. 4 and FIG. 5. Preferably, the pixel value differences pix_diff are positive values, and thus are equal to absolute values of the real pixel value differences obtained from the pixels P4 and P5. Then, if the pixel value differences pix_diff are greater than a second threshold value TH2, the block boundaries are determined to be sharp and have to be determined whether the real edges of the objects in the picture. Certainly, in the present invention, the second threshold value TH2 is not a fixed value, but can also be adjusted according to the desired image quality and the processing efficiency.

Next, the present invention determines whether the block boundaries are real edges of the objects in the picture according to the pixel value differences pix_diff. If the pixel value differences pix_diff are both smaller than two values which are a third threshold value TH3 multiplying the quantization parameters of the two adjacent blocks at both sides of the block boundaries, the block boundaries are then determined to be not the real edges of the objects in the picture. When the block boundaries are sharp and are not real edges of the objects in the pictures, which indicating that there are indeed the blocking artifacts on the block boundaries, the de-blocking operation has to be performed for the blocks corresponding to the block boundaries. Conversely, if the block boundaries are real edges of the objects in the picture, the block boundaries need not to be performed the following de-blocking operation for avoiding blurring the corresponding images.

In order to determine the third threshold value TH3, the present invention can determine in advance that smoothness or local image characteristics around the block boundaries. For example, when the image around the block boundaries is smooth, the pixel value difference between the two adjacent pixels respectively located at both sides of the block boundary is highly possible to be a blocking artifact but not a real edge of the objects in the picture. Thus, for the smooth image region in the picture, the third threshold value TH3 can be set as a larger value. Conversely, when the image around the block boundaries is complex, the pixel value difference is possible to be a real edge of the objects in the picture, and thus for the complex image region in the picture, the third threshold value TH3 can be set as a smaller value. Therefore, in the present invention, the de-blocking operation can be appropriately performed according to the image characteristics and the quantization parameters, so as to prevent from excessively blurring the image or still remaining apparent boundary lines. Preferably, the third threshold value can be a value selected from 0.5, 1, 1.5, 2 and 2.5, and can be further adjusted according to the desired image quality and the processing efficiency.

When the block boundaries are sharp and are not real edges of the objects in the pictures, the block boundaries need to be performed the de-blocking operation for reducing the blocking artifacts. The present invention then selects filtering strengths of the de-blocking operation corresponding to pixels of the two adjacent blocks at both sides of the block boundaries according to the pixel value differences pix_diff (Step 240). In the present invention, the filtering strengths of the de-blocking operation can be obtained by multiplying various weighting values with the pixel value differences pix_diff between the two pixels respectively located at both side of the block boundaries according to the desired image quality, so as to enhance accuracy and flexibility of the de-blocking filtering operation. Preferably, the weighting values can be a value selected from 1/8, 2/8, 3/8, 4/8, 5/8, 6/8, 7/8, 8/8, 9/8, and 10/8, and are not restricted herein.

After selecting the filtering strengths of the de-blocking operation, the present invention can perform the de-blocking operation for the two adjacent blocks at both sides of the block boundaries (Step 250). When performing the de-blocking operation, the present invention selects four pixels at both sides of the block boundaries, i.e. the pixels P1˜P8 shown in FIG. 4 and FIG. 5, for filtering the blocking artifacts. Then, the present invention can determine a filtering range for altering the pixel values of the corresponding pixels according to the smoothness or the local image characteristics around the block boundaries. For example, when the images around the block boundaries are smooth, the filtering range includes three corresponding pixels at both side of the block boundaries, i.e. the pixels P2˜P7 in FIG. 4 and FIG. 5, and conversely, when the images around the block boundaries are not smooth or are complex, two pixels at both side of the block boundaries, i.e. the pixels P3˜P6 in FIG. 4 and FIG. 5, are included, for avoiding reducing the sharpness of the images or excessively blurring the images.

On the other hand, if the picture is formed by two interlaced image fields, the present invention then separately performs the de-blocking operation for the odd fields and the even fields when processing the horizontal block boundaries. That means, the odd row pixels and the even row pixels are separately de-blocking filtered when processing the horizontal block boundaries of the interlaced picture. For example, the filtering range includes two odd row pixels at both the top and bottom sides of the block boundaries, i.e. the pixels P1, P3, P5 and P7 in FIG. 5, when performing the de-blocking operation for the odd fields. Similarly, the filtering range includes two even row pixels at both the top and bottom sides of the block boundaries (i.e. the pixels P2, P4, P6 and P8 in FIG. 5) when performing the de-blocking for the even image field. Thus, with the slight modifications, the de-blocking operation of the present invention can be applied for the interlaced pictures when processing the vertical block boundaries.

As mentioned above, the filtering strengths of each two corresponding pixels at both sides of the block boundaries can be determined according to the pixel difference pix_diff. Thus, when performing the de-blocking operation, the present invention can respectively increase and decrease the pixel values of each two corresponding pixels at both sides of the block boundaries with the appropriate filtering strengths for lessening the pixel value differences according to their original pixel values, so as to reduce the blocking artifacts. In other words, when performing the de-blocking operation, the pixel value of the pixel with a smaller pixel value in a pixel pair are added with the corresponding filtering strength, and the pixel value of the pixel with a larger pixel value in the pixel pair are subtracted with the same filtering strength, so that the pixel value difference between the pixel pair can be lessened. After performing the filtering operation for all of the pixel pairs at both sides of the block boundaries according to the filtering range, the present invention adjusts all of the altered pixel values of the pixels at both sides of the block boundaries to lie in between the values 0 and 255.

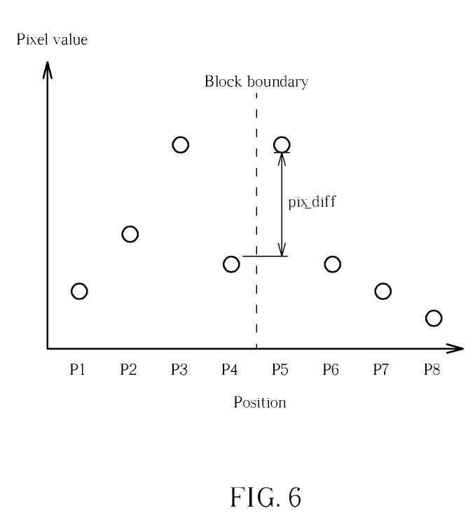

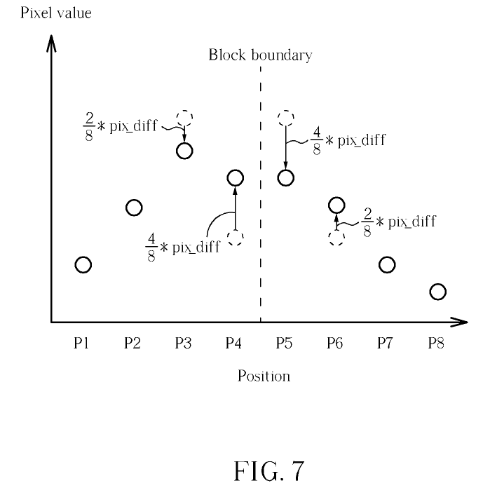

Please refer to FIG. 6 and FIG. 7. FIG. 6 and FIG. 7 are schematic diagrams of pixel values corresponding to pixels P1˜P8 at both sides of the block boundaries before and after performing the de-blocking operation, respectively. In FIG. 6 and FIG. 7, the pixels P1˜P8 are corresponding to that of FIG. 4 and FIG. 5, and the block boundary can be a vertical block boundary or a horizontal block boundary. When the pixel difference pix_diff between the pixels P4 and P5 is greater than the second threshold value TH2 and the block boundary is determined not a real edge of the objects in the picture, the de-blocking filtering operation is then performed for the pixels P1˜P8 according to the local image characteristics around the block boundary. In this embodiment, if the image around the block boundary is complex, the two corresponding pixel pairs, i.e. the pixel pair P4 and P5 and the pixel pair P3 and P6, are then de-blocking filtered with the appropriately selected filtering strengths. Assumed that the filtering strengths corresponding to the two pixel pairs are selected as the values (4/8* pix_diff) and (2/8*pix_diff), and thus as shown in FIG. 7, the pixel values of the pixels P4 and P5 are respectively added and subtracted with the value (4/8*pix_diff) and the pixel values of the pixels P3 and P6 are respectively added and subtracted with the value (2/8*pix_diff), with a result that the pixel value differences between the pixel pairs can be lessened, and further, the blocking artifacts can be reduced.

Therefore, in the present invention, before performing the de-blocking operation, the blocks that exist the blocking artifacts on their bock boundaries can be detected in advance according to the quantization parameters obtained from the decoding information of the MPEG-2 decoder and the image characteristics, so that the efficiency of the decoding system can be enhanced significantly. Moreover, the present invention can perform the de-blocking operation for the blocks with the blocking artifacts by the adaptive filtering strengths, and thus the blocking artifacts can be eliminated effectively and the desired image quality can be obtained as well.

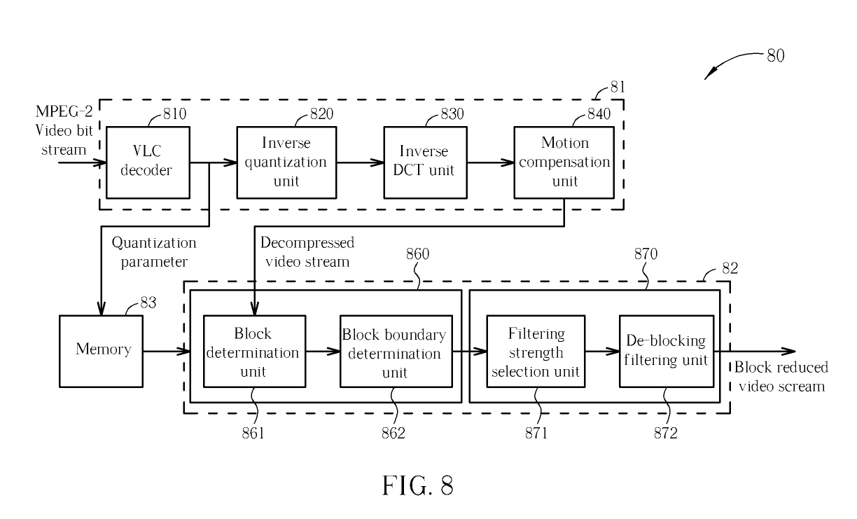

Please refer to FIG. 8. FIG. 8 is a function block diagram of a video decoding system 80 according to the present invention. The video decoding system 80 includes a video decoder 81, a de-blocking device 82 and a memory 83. The video decoder 81 is a standard MPEG-2 decoder, and includes a variable length code (VLC) decoder 810, an inverse quantization unit 820, an inverse discrete cosine transform (DCT) unit 830 and a motion compensation unit 840. The operation of the video decoder 81 is well known by those skilled in the art, and thus is not narrated herein. The memory 83 is coupled to the video decoder 81, and is utilized for storing decoding information such as quantization parameters during the MPEG-2 decompression process. After an MPEG-2 video bit stream is received and decompressed by the video decoder 81, a decompressed video stream is then generated and inputted into the de-blocking device 82 for reducing the blocking artifacts.

The de-blocking device 82 is utilized for realizing the process 20 of the present invention, and includes a blocking artifact detection unit 860 and a blocking artifact elimination unit 870. The blocking artifact detection unit 860 is utilized for detecting the blocking artifacts in a picture of the decompressed video stream according to the quantization parameters stored in the memory 83, and includes a block determination unit 861 and a block boundary determination unit 862. The block determination unit 861 is coupled to the video decoder 81 and the memory 83, and is utilized for determining the blocks with the quantization parameters greater than the first threshold value in the picture. The block boundary determination unit 862 is coupled to the block determination unit 861, and is utilized for checking if the block boundaries of the blocks are sharp and are real edges of the objects in the picture according to the pixel value differences pix_diff between two adjacent pixels respectively located at both sides of the block boundaries.

After the blocking artifacts are detected by the blocking artifact detection unit 860, the blocking artifact elimination unit 870 performs the de-blocking operation for the blocks with the blocking artifacts detected by the blocking artifact detection unit 860. The blocking artifact elimination unit 870 is coupled to the blocking artifact detection unit 860, and includes a filtering strength selection unit 871 and a de-blocking filtering unit 872. The filtering strength selection unit 871 is coupled to the block boundary determination unit 862, and is utilized for selecting the filtering strengths of the de-blocking operation according to the pixel value differences pix_diff. The de-blocking filtering unit 872 is coupled to the filtering strength selection unit, and is utilized for performing the de-blocking operation for two adjacent blocks at both sides of the block boundaries that are sharp and are not real edges of the objects in the picture.

Thus, with the blocking artifact detection unit 860, the present invention can detect the blocks that have the blocking artifacts on their bock boundaries, and with blocking artifact elimination unit 870, the present invention can perform the de-blocking operation for the blocks with the blocking artifacts by adaptive filtering strengths, so that not only the efficiency of the decoding system can be enhanced, but the desired image quality can also be obtained.

Note that, the de-blocking device 82 is utilized for realizing the process 20, and thus the related operation will not be narrated in detail. Certainly, those skilled in the art can further implement the de-blocking device with any hardware and firmware or make appropriate modifications according to practical demands, which are still in the range of the present invention.

In summary, the present invention provides the method and related device for detecting the blocking artifacts and reducing the blocking artifacts with adaptive de-blocking filtering strength. Besides, in the present invention, all of the parameters are adaptive, so as to enhance accuracy and flexibility of the de-blocking filtering operation.

Those skilled in the art will readily observe that numerous modifications and alterations of the device and method may be made while retaining the teachings of the invention.

What is claimed is:

1. A method for reducing blocking artifacts in a video stream comprising:
receiving a picture of the video stream, the picture comprising a plurality of macroblocks and each of the plurality of macroblock comprising four blocks;
determining blocks with quantization parameters greater than a first threshold value in the picture;
checking if block boundaries of the blocks are sharp and are real edges of objects in the picture according to pixel value differences between two adjacent pixels respectively located at both sides of the block boundaries;
selecting filtering strengths of a de-blocking operation according to the pixel value differences when the block boundaries are sharp and are not real edges of the objects in the picture; and
performing the de-blocking operation for two adjacent blocks at both sides of the block boundaries.

2. The method of claim 1, wherein the first threshold value is adaptive according to desired image quality and processing capability.

3. The method of claim 1, wherein checking if the block boundaries of the blocks are sharp and are the real edges of the objects in the picture according to the pixel value differences between two adjacent pixels respectively located at both sides of the block boundaries comprises:
determining whether the block boundaries of the blocks are sharp according to the pixel value differences and a second threshold value; and
determining whether the block boundaries of the blocks are real edges of the objects in the picture according to the pixel value differences, a third threshold value and quantization parameters of two adjacent blocks at both sides of the block boundaries.

4. The method of claim 3, wherein the second threshold value is adaptive according to desired image quality and processing capability.

5. The method of claim 3, wherein the third threshold value is adaptive according to smoothness of images around block boundaries of the blocks, desired image quality and processing capability.

6. The method of claim 5, wherein the third threshold value is a value selected from 0.5, 1, 1.5, 2 and 2.5.

7. The method of claim 1, wherein the filtering strengths of the de-blocking operation comprises the pixel value differences multiplying values selected from 1/8, 2/8, 3/8, 4/8, 5/8, 6/8, 7/8, 8/8, 9/8, and 10/8.

8. The method of claim 1 further comprising determining smoothness of images around block boundaries of the blocks with the quantization parameters greater than the first threshold value.

9. The method of claim 8, wherein performing the de-blocking operation for the two adjacent blocks at both sides of the block boundaries comprises:
adjusting pixel value differences of three corresponding pixel pairs in the two adjacent blocks at both sides of the block boundaries according to the selected filtering strengths when the image around the block boundaries are smooth.
adjusting pixel value differences of two corresponding pixel pairs in the two adjacent blocks at both sides of the block boundaries according to the selected filtering strengths when the image around the block boundaries are complex.

10. The method of claim 8, wherein performing the de-blocking operation for the two adjacent blocks at both sides of the block boundaries is adjusting pixel value differences of corresponding pixel pairs in the two adjacent blocks at both sides of the block boundaries according to the selected filtering strength, the adjusted pixel values are values between 0 and 255.

11. The method of claim 8, wherein performing the de-blocking operation for the two adjacent blocks at both sides of the block boundaries comprises separately performing the de-blocking operation for odd image fields and even image fields of the two adjacent blocks at both sides of the horizontal block boundaries when the picture is an interlaced picture.

12. The method of claim 11, wherein separately performing the de-blocking operation for odd image fields and even image fields of the two adjacent blocks at both sides of the horizontal block boundaries when the picture is an interlaced picture comprises separately adjusting pixel value differences of two corresponding odd row pixel pairs and two corresponding even row pixel pairs of the two adjacent blocks at both sides of the block boundaries when the image around the block boundaries are smooth.

13. The method of claim 1, wherein the video stream is outputted from an MPEG-2 decoder.

14. A de-blocking device for reducing blocking artifacts in a video stream comprising:
a reception terminal for receiving a picture of the video stream, the picture comprising a plurality of macroblocks and each of the plurality of macroblock comprising four blocks;
a blocking artifact detection unit comprising:
a block determination unit, coupled to the reception terminal, for determining blocks with quantization parameters greater than a first threshold value in the picture; and
a block boundary determination unit, coupled to the block determination unit, for checking if block boundaries of the blocks are sharp and are real edges of objects in the picture according to pixel value differences between two adjacent pixels respectively located at both sides of the block boundaries; and
a blocking artifact elimination unit comprising:
a filtering strength selection unit, coupled to the block boundary determination unit, for selecting filtering strengths of a de-blocking operation according to the pixel value differences when the block boundaries are sharp and are not real edges of the objects in the picture; and
a de-blocking filtering unit, coupled to the filtering strength selection unit, for performing the de-blocking operation for two adjacent blocks at both sides of the block boundaries.

15. The de-blocking device of claim 14, wherein the first threshold value is adaptive according to desired image quality and processing capability.

16. The de-blocking device of claim 14, wherein the block boundary determination unit is further utilized for:
determining whether the block boundaries of the blocks are sharp according to the pixel value differences and a second threshold value; and
determining whether the block boundaries of the blocks are real edges of the objects in the picture according to the pixel value differences, a third threshold value and quantization parameters of two adjacent blocks at both sides of the block boundaries.

17. The de-blocking device of claim 16, wherein the second threshold value is adaptive according to desired image quality and processing capability.

18. The de-blocking device of claim 16, wherein the third threshold value is adaptive according to smoothness of images around block boundaries of the blocks, desired image quality and processing capability.

19. The de-blocking device of claim 18, wherein the third threshold value is a value selected from 0.5, 1, 1.5, 2 and 2.5.

20. The de-blocking device of claim 14, wherein the filtering strengths of the de-blocking operation comprises the pixel value differences multiplying values selected from 1/8, 2/8, 3/8, 4/8, 5/8, 6/8, 7/8, 8/8, 9/8, and 10/8.

21. The de-blocking device of claim 14 further comprising a smoothness determination unit, coupled to the reception end, for determining smoothness of the image around block boundaries of the blocks with the quantization parameters greater than the first threshold value.

22. The de-blocking device of claim 21, wherein the de-blocking filtering unit is further utilized for:
adjusting pixel value differences of three corresponding pixel pairs in the two adjacent blocks at both sides of the block boundaries according to the selected filtering strengths when the image around the block boundaries are smooth.
adjusting pixel value differences of two corresponding pixel pairs in the two adjacent blocks at both sides of the block boundaries according to the selected filtering strengths when the image around the block boundaries are complex.

23. The de-blocking device of claim 21, wherein the de-blocking filtering unit is further utilized for adjusting pixel value differences of corresponding pixel pairs in the two adjacent blocks at both sides of the block boundaries according to the selected filtering strength, the adjusted pixel values are values between 0 and 255.

24. The de-blocking device of claim 21, wherein the de-blocking filtering unit is further utilized for separately performing the de-blocking operation for odd image fields and even image fields of the two adjacent blocks at both sides of the horizontal block boundaries when the picture is an interlaced picture.

25. The de-blocking device of claim 24, wherein the de-blocking filtering unit is further utilized for separately adjusting pixel value differences of two corresponding odd row pixel pairs and two corresponding even row pixel pairs of the two adjacent blocks at both sides of the block boundaries when the image around the block boundaries are smooth.
